(19) United States
(12) Patent Application Publication
(10) Pub. No.: US 2025/0338182 A1
(43) Pub. Date: Oct. 30, 2025

(54) METHOD OF INTER-DONOR MIGRATION AND APPARATUS THEREOF

(71) Applicant: ZTE CORPORATION, Shenzhen (CN)

(72) Inventors: Ying HUANG, Shenzhen (CN); Lin CHEN, Shenzhen (CN)

(73) Assignee: ZTE CORPORATION, Shenzhen (CN)

(21) Appl. No.: 19/228,909

(22) Filed: Jun. 5, 2025

Related U.S. Application Data
(63) Continuation of application No. PCT/CN2023/076808, filed on Feb. 17, 2023.

(51) Int. Cl. H04W 36/00

(52) U.S. Cl. CPC H04W 36/0072

(57) ABSTRACT

A wireless communication method for use in a target Integrated Access and Backhaul (IAB) donor is disclosed. The method comprises: receiving, from an F1 terminating donor of an IAB node, a IAB transport migration management request message, wherein the IAB transport migration management request message comprises at least one of a first identifier allocated by the F1 terminating donor or a second identifier allocated by the target IAB donor of a mobile termination of the IAB node.

### CROSS-REFERENCE TO RELATED PATENT APPLICATIONS

This application is a Continuation of US Application PCT/CN2023/076808, filed Feb. 17, 2023, incorporated herein by reference in its entirety.

### TECHNICAL FIELD

This document is directed generally to wireless communications, and in particular to 5G communications.

### BACKGROUND

Integrated Access and Backhaul (IAB) supporting wireless backhauling via NR (new radio) enables flexible and very dense deployment of NR cells while reducing the need for a wireline transport infrastructure.

### SUMMARY

Intra-donor CU migration procedure has been studied and specified in R16 IAB in which both the source and the target parent node are served by the same IAB-donor-CU. In addition, inter-donor CU migration was discussed in R17 IAB where the migrating IAB node is static. However, there is no discussion for inter-donor migration in the mobile IAB use case as shown in FIG. 1. As shown in FIG. 1, IAB node(s) may be mounted in vehicles and can provide 5G coverage/capacity enhancement to onboard and/or surrounding UEs (e.g., UE1 and UE2 in FIG. 1).

The present disclosure relates to a wireless communication method for use in a target Integrated Access and Backhaul (IAB) donor. The method comprises: receiving, from an F1 terminating donor of an IAB node, a IAB transport migration management request message, wherein the IAB transport migration management request message comprises at least one of a first identifier allocated by the F1 terminating donor or a second identifier allocated by the target IAB donor of a mobile termination of the IAB node.

Various embodiments may preferably implement the following features:

Preferably or in some embodiments, the method further comprises: receiving, from a source IAB donor of the mobile termination of the IAB node, the first identifier.

Preferably or in some embodiments, the first identifier and the second identifier are Xn application protocol identifiers.

The present disclosure also relates to a wireless communication method for use in an F1 terminating Integrated Access and Backhaul (IAB) donor for an IAB node. The method comprises: transmitting, to a target IAB donor of a mobile termination of the IAB node, a IAB transport migration management request message, wherein the IAB transport migration management request message comprises at least one of a first identifier allocated by the F1 terminating donor or a second identifier allocated by the target IAB donor.

Various embodiments may preferably implement the following features:

Preferably or in some embodiments, the method further comprises: receiving, from a source IAB donor of the mobile termination of the IAB node, the second identifier.

Preferably or in some embodiments, the first identifier and the second identifier are Xn application protocol identifiers.

The present disclosure also relates to a wireless communication method for use in a source Integrated Access and Backhaul (IAB) donor. The method comprises: transmitting, to a target IAB donor, a conditional handover request message for an IAB node, transmitting, to the IAB node, a configuration of a conditional handover to the target IAB donor, receiving, from the IAB node, target information of the conditional handover to the target IAB donor, and transmitting, to an F1 terminating donor of the IAB node, the target information.

Various embodiments may preferably implement the following features:

Preferably or in some embodiments, the configuration of the conditional handover comprises at least one triggering condition configured by the source IAB donor for transmitting the target information.

Preferably or in some embodiments, the at least one triggering condition configured by the source IAB donor for transmitting the target information comprises at least one of: a measurement threshold for serving cell, a measurement threshold for a special cell, a measurement threshold for a primary cell, a measurement threshold of a primary secondary cell, a measurement threshold for a neighbor cell, a measurement threshold for a conditional reconfiguration candidate cell, or a threshold for measurement offset between the special and the conditional reconfiguration candidate cell.

The present disclosure also relates to a wireless communication method for use in an Integrated Access and Backhaul (IAB) node. The method comprises: receiving, from a source IAB donor, a configuration of a conditional handover to a target IAB donor, and transmitting, to the source IAB donor or an F1 terminating donor of the IAB node, target information of the conditional handover to the target IAB donor.

Various embodiments may preferably implement the following features:

Preferably or in some embodiments, the configuration of the conditional handover comprises at least one triggering condition configured by the source IAB donor for transmitting the target information.

Preferably or in some embodiments, the at least one triggering condition configured by the source IAB donor for transmitting the target information comprises at least one of: a measurement threshold for serving cell, a measurement threshold for a special cell, a measurement threshold for a primary cell, a measurement threshold of a primary secondary cell, a measurement threshold for a neighbor cell, a measurement threshold for a conditional reconfiguration candidate cell, or a threshold for measurement offset between the special and the conditional reconfiguration candidate cell.

The present disclosure also relates to a wireless communication method for use in a first Integrated Access and Backhaul (IAB) donor. The method comprises: transmitting, to at least one second IAB donor, a request message associated with an IAB node, and receiving, from the at least one second IAB donor, a response message comprising migration capability information of the at least one second IAB donor.

Various embodiments may preferably implement the following features:

Preferably or in some embodiments, the wireless communication method further comprises determining one of the at least one second IAB donor as a target IAB donor for a migration for the IAB node based on the migration capability information of the at least one second IAB donor.

Preferably or in some embodiments, the request message comprises at least one of: quality-of-service (QOS) information of traffic associated with the migration, a number of user terminals served by the DU of the IAB node, a velocity of the IAB node, a location of the IAB node, a Backhaul Adaptation Protocol (BAP) routing identifier, or a Backhaul (BH) radio link control (RLC) channel identifier.

Preferably or in some embodiments, the migration capability information comprises at least one of: information of traffic capable of being added to the second IAB donor, a number of user terminals capable of being migrated to the second IAB donor, a BAP routing identifier, or a BH RLC channel identifier.

The present disclosure also relates to a wireless communication method for use in a target Integrated Access and Backhaul (IAB) donor. The method comprises: receiving, from a target logical distributed unit (DU) of an IAB node, an F1 setup request message, wherein the Fl setup request message comprises at least one of a mobile IAB indication, an identity of a source IAB donor, an identity of the IAB node, or a DU identity of a source logical DU of the IAB node, and transmitting, to the source IAB donor, an F1 setup completion message comprising at least one of the identity of the IAB node, the DU identity of the source logical DU of the IAB node, or an identity of a mobile termination of the IAB node.

Various embodiments may preferably implement the following features:

Preferably or in some embodiments, the identity of the IAB node comprises at least one of a Backhaul Adaptation Protocol (BAP) address, a cell radio network temporary identifier, or a XnAP identifier allocated by the source IAB donor.

Preferably or in some embodiments, the identity of a mobile termination of the IAB node comprises at least one of a Backhaul Adaptation Protocol (BAP) address, a cell radio network temporary identifier, or an XnAP identifier allocated by the source IAB donor.

The present disclosure also relates to a wireless communication method for use in an Integrated Access and Backhaul (IAB) node. The method comprises: transmitting, to a target IAB donor, an F1 setup request message, wherein the F1 setup request message comprises at least one of a mobile IAB indication, an identity of a source IAB donor, an identity of the IAB node, or a DU identity of a source logical DU of the IAB node.

Various embodiments may preferably implement the following features:

Preferably or in some embodiments, the identity of the IAB node comprises at least one of a Backhaul Adaptation Protocol (BAP) address, a cell radio network temporary identifier, or an XnAP identifier allocated by the source IAB donor.

Preferably or in some embodiments, the method further comprises: receiving, from the source IAB donor, an XnAP identifier allocated by the source IAB donor for the IAB node.

The present disclosure also relates to a wireless communication method for use in an Integrated Access and Backhaul (IAB) node. The method comprises: transmitting, to a target IAB donor, an F1 setup message, receiving, from the target IAB donor, an F1 setup response message, and transmitting, to a source IAB donor, an F1 setup completion message.

Various embodiments may preferably implement the following features:

Preferably or in some embodiments, the F1 set up completion message comprises at least one of a F1 setup completion indication or an identity of the target IAB donor.

The present disclosure also relates to a wireless communication method for use in an Integrated Access and Backhaul (IAB) node. The method comprises: transmitting, to an IAB donor serving the IAB node, an internet protocol (IP) address request, and receiving, from the IAB donor, IP address information.

Various embodiments may preferably implement the following features:

Preferably or in some embodiments, the IP address request comprises at least one of a number of requested IP addresses, IP address usage, a DU migration indication, a target logical DU indication, or a topology indication.

Preferably or in some embodiments, the IP address information comprises at least one of at least one allocated IP address, IP address usage, a DU migration indication, a target logical DU indication, or a topology indication.

The present disclosure also relates to a wireless communication method for use in an FI terminating Integrated Access and Backhaul (IAB) donor of an IAB node. The method comprises: transmitting, to a target IAB donor, an internet protocol (IP) address request for the IAB node.

Various embodiments may preferably implement the following features:

Preferably or in some embodiments, the IP address request comprises at least one of a number of requested IP addresses, IP address usage, a DU migration indication, a target logical DU indication, or a topology indication.

Preferably or in some embodiments, the method further comprises: receiving, from the target IAB donor, IP address information for the IAB node, and transmitting, to the IAB node, the IP address information.

Preferably or in some embodiments, the IP address information comprises at least one of at least one allocated IP address, IP address usage, a DU migration indication, a target logical DU indication, or a topology indication.

The present disclosure also relates to a wireless communication method for use in a target Integrated Access and Backhaul (IAB) donor. The method comprises: receiving, from an IAB node or an F1 terminating IAB donor of the IAB node, an internet protocol (IP) address request for the IAB node, and transmitting, to the mobile termination of the IAB node or the F1 terminating IAB donor, IP address information for the IAB node.

Various embodiments may preferably implement the following features:

Preferably or in some embodiments, the IP address request comprises at least one of a number of requested IP addresses, IP address usage, a DU migration indication, a target logical DU indication, or a topology indication.

Preferably or in some embodiments, the IP address information comprises at least one of at least one allocated IP address, IP address usage, a DU migration indication, a target logical DU indication, or a topology indication.

The present disclosure also relates to a wireless communication method for use in a source Integrated Access and Backhaul (IAB) donor. The method comprises: transmitting, to a target IAB donor, uplink mapping information used at an IAB node.

The present disclosure also relates to a wireless communication method for use in a target Integrated Access and Backhaul (IAB) donor. The method comprises: receiving, from a source IAB donor, uplink mapping information used at an IAB node, and transmitting, to the IAB node, the updated uplink mapping information.

The present disclosure also relates to a wireless communication method for use in an Integrated Access and Backhaul (IAB) donor. The method comprises: transmitting, to an IAB node, a share indication of a source logical distributed unit (DU) and a target logic DU of the IAB node.

Various embodiments may preferably implement the following features:

Preferably or in some embodiments, the IAB donor is a source IAB donor of a mobile termination of the IAB node, a target IAB donor of the mobile termination of the IAB node, a source IAB donor of a DU of the IAB node or a target donor of the DU of the IAB node.

The present disclosure also relates to a wireless communication method for use in an Integrated Access and Backhaul (IAB) node. The method comprises: receiving, from an IAB donor, a share indication of a source logical distributed unit (DU) and a target logic DU of the IAB node.

Various embodiments may preferably implement the following features:

Preferably or in some embodiments, the IAB donor is a source IAB donor of a mobile termination of the IAB node, a target IAB donor of the mobile termination of the IAB node, a source IAB donor of a DU of the IAB node or a target donor of the DU of the IAB node.

Preferably or in some embodiments, the method further comprises: transmitting, from the source logical DU to the target logical DU, configuration information associated with the uplink mapping configuration of the source logical DU.

The present disclosure also relates to a wireless communication method for use in an Integrated Access and Backhaul (IAB) node. The method comprises: transmitting, to a source IAB donor, an internet protocol (IP) address used by a target logic DU of the IAB node.

The present disclosure also relates to a wireless communication method for use in a source Integrated Access and Backhaul (IAB) donor. The method comprises: receiving, from a source logical distributed unit (DU) of an IAB node, an internet protocol (IP) address used by a target logic DU of the IAB node, and transmitting, to a target IAB donor, the IP address.

The present disclosure also relates to a wireless communication method for use in a target Integrated Access and Backhaul (IAB) donor. The method comprises: transmitting, to an IAB donor of a mobile termination of an IAB node, assistance information, receiving, from the IAB donor of the mobile termination of the IAB node, information for an internet protocol (IP) header.

Various embodiments may preferably implement the following features:

Preferably or in some embodiments, the assistance information includes at least one of an internet protocol address of the IAB node, quality of service (QOS) information of the traffic, an identity of the IAB node allocated by the IAB donor of the mobile terminal of the IAB node.

Preferably or in some embodiments, the information for the IP header comprises at least one of a differentiated services code point (DSCP), a flow label or traffic information.

Preferably or in some embodiments, the method further comprises: receiving, from the target logic DU, an identity of the IAB donor of the mobile termination of the IAB node and/or an identity of the IAB node allocated by the IAB donor of the mobile terminal of the IAB node.

The present disclosure also relates to a wireless communication method for use in an Integrated Access and Backhaul (IAB) donor. The method comprises: receiving, from a target IAB donor connected with a distributed unit (DU) of an IAB node, assistance information for configuring a DL mapping, wherein the IAB donor is for a mobile termination of the IAB node, transmitting, to the target IAB donor, information for an internet protocol (IP) header.

Various embodiments may preferably implement the following features:

Preferably or in some embodiments, the assistance information includes at least one of an internet protocol address of the IAB node, quality of service (QOS) information of the traffic, an identity of the IAB node allocated by the IAB donor of the mobile terminal of the IAB node.

Preferably or in some embodiments, the information for IP header comprises at least one of a differentiated services code point DSCP, a flow label or traffic information.

Preferably or in some embodiments, the method further comprises: transmitting, to the IAB node, an identity of the IAB node allocated by the IAB donor.

The present disclosure also relates to a wireless device, comprising a communication unit and a processor, the processor being configured to perform a wireless communication method recited in any one of the foregoing methods.

The present disclosure relates to a computer program product comprising a computer-readable program medium code stored thereupon, the code, when executed by a processor, causing the processor to implement a wireless communication method recited in any one of the foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The invention is specified by the independent claims. Preferred embodiments are defined in the dependent claims. In the following description, although numerous features may be designated as optional, it is nevertheless acknowledged that all features comprised in the independent claims are not to be read as optional.

### BRIEF DESCRIPTION OF THE DRAWINGS

The above and other aspects and their implementations are described in greater detail in the drawings, the descriptions, and the claims.

FIG. 1 shows a schematic diagram of a network.

FIG. 2 shows a schematic diagram of an integrated access and backhaul architecture according to an embodiment of the present disclosure.

FIG. 3 shows a schematic diagram of a parent/child node relationship for the IAB node according to an embodiment of the present disclosure.

FIGS. 4A to 4C show schematic diagrams of migrations in the IAB architecture according to embodiments of the present disclosure.

FIG. 5 shows a schematic diagram of an inter-donor full migration according to an embodiment of the present disclosure.

FIG. 6 shows a flowchart of a process according to an embodiment of the present disclosure.

FIG. 7 shows a flowchart of a process according to an embodiment of the present disclosure.

FIG. 8 shows a flowchart of a process according to an embodiment of the present disclosure.

FIG. 9 shows a flowchart of a process according to an embodiment of the present disclosure.

FIG. 10 shows a flowchart of a process according to an embodiment of the present disclosure.

FIG. 11 shows a flowchart of a process according to an embodiment of the present disclosure.

FIG. 12 shows a flowchart of a process according to an embodiment of the present disclosure.

FIG. 13 shows a flowchart of a process according to an embodiment of the present disclosure.

FIG. 14 shows a flowchart of a process according to an embodiment of the present disclosure.

FIG. 15 shows a flowchart of a process according to an embodiment of the present disclosure.

FIG. 16 shows a flowchart of a process according to an embodiment of the present disclosure.

FIG. 17 shows a flowchart of a process according to an embodiment of the present disclosure.

FIG. 18 shows an example of a schematic diagram of a wireless terminal according to an embodiment of the present disclosure.

FIG. 19 shows an example of a schematic diagram of a wireless network node according to an embodiment of the present disclosure.

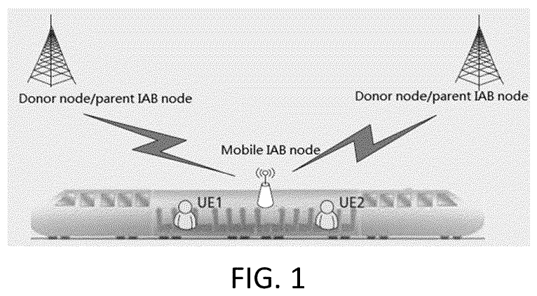

### DETAILED DESCRIPTION

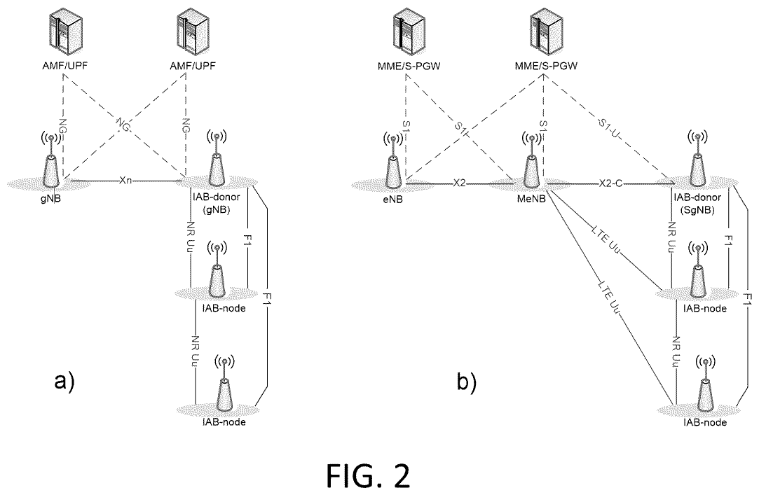

FIG. 2 shows a schematic diagram of an integrated access and backhaul (IAB) architecture according to an embodiment of the present disclosure. The IAB enables wireless relaying in NG-RAN (next-generation radio access network). The relaying node, referred to as IAB-node, supports access and backhauling via the NR. The terminating node of NR backhauling on the network side is referred to as the IAB-donor, which represents a gNB with additional functionality of supporting the IAB. The backhauling can occur via a single or via multiple hops.

The IAB-node supports gNB-DU functionality, to terminate the NR access interface to UEs and next-hop IAB-nodes, and to terminate the F1 protocol to the gNB-CU functionality on the IAB-donor. The gNB-DU functionality on the IAB-node is also referred to as IAB-DU.

In addition to the gNB-DU functionality, the IAB-node also supports a subset of the UE functionality referred to as IAB-MT (mobile termination), which includes, e.g., physical layer, layer-2, RRC and NAS functionality to connect to the gNB-DU of another IAB-node or the IAB-donor and to connect to the gNB-CU on the IAB-donor and to the core network.

The IAB-node can access the network using either SA-mode (e.g., FIG. 2 (a)) or EN-DC (e.g., FIG. 2 (b)). In the EN-DC, the IAB-node also connects via E-UTRA to a MeNB, and the IAB-donor terminates X2-C as SgNB.

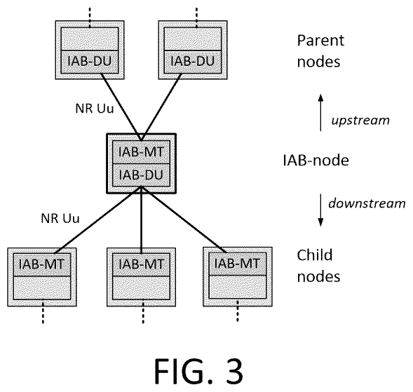

FIG. 3 shows a schematic diagram of a parent/child node relationship for the IAB node according to an embodiment of the present disclosure. In FIG. 3, all IAB-nodes that are connected to an IAB-donor via one or multiple hops form a directed acyclic graph (DAG) topology with the IAB-donor at its root. In this DAG topology, the neighbor node on the interface of the IAB-DU is referred to as child node and the neighbor node on the interface of the IAB-MT is referred to as parent node. The direction toward the child node is further referred to as downstream while the direction toward the parent node is referred to as upstream. The IAB-donor performs centralized resource, topology and route management for the IAB topology.

In an embodiment, Partial Migration refers to a migration of an IAB-MT to a parent node underneath a different IAB-donor-CU while the co-located IAB-DU and descendant IAB-node(s), if any, are not migrated (i.e., terminated at the initial IAB-donor-CU).

In an embodiment, full Migration represents that the migrating IAB node (i.e., the mobile IAB node in the mobile IAB scenario) and the descendant IAB node(s) (if any) are migrated (both RRC and F1 connection) from one IAB-donor-CU to another IAB-donor-CU.

In an embodiment, an F1-terminating IAB-donor refers to an IAB-donor that terminates the F1 (interface) for an IAB-node. The F1 terminating IAB donor may also be named as a donor of the DU (in/of the IAB-node).

In an embodiment, there may be two logical DUs in the mobile IAB node. The two logical DUs in the mobile IAB node can be called source logical DU and target logical DU or logical DU1 and logical DU2.

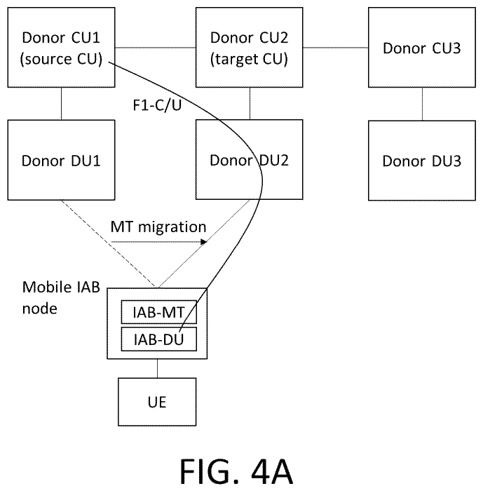

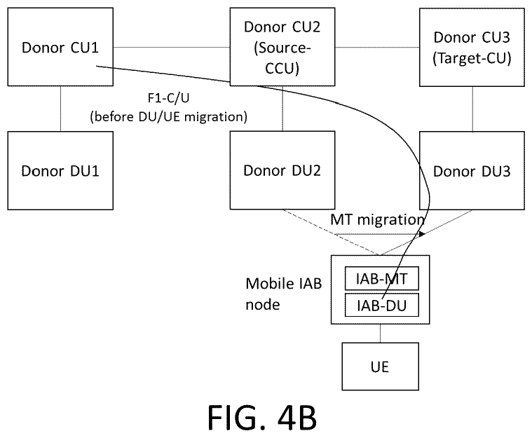

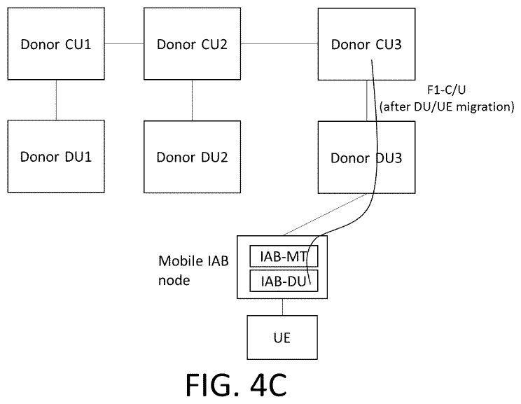

FIGS. 4A to 4C show schematic diagrams of migrations in the IAB architecture according to embodiments of the present disclosure. In FIG. 4A, the partial migration is performed. The IAB-MT migrates from a donor DU1 which belongs to a donor CU1 to a donor DU2 which belongs to a donor CU2. Note that the IAB-DU maintains its F1 connection with the donor CU1 and its UE context remains in the donor CU1. In this embodiment, F1-C/U traffic between the donor CU1 and the IAB-DU is transmitted via the donor DU2.

In FIG. 4B, the partial migration is performed. The IAB-MT migrates from the donor DU2 which belongs to the donor CU2 to a donor DU3 which belongs to a donor CU3. In this embodiment, the IAB-DU maintains its F1 connection with the donor CU1 and the UE context remains in the donor CU1. F1-C/U traffic between the donor CU1 and the IAB-DU is transmitted via the donor DU3.

In FIG. 4C, the full migration is performed. That is the MT and DU of the IAB node are migrated to the same donor. Specifically, the IAB-DU migrates from the donor CU1 to the donor CU3 and the UE is handed over from the donor CU1 to the donor CU3. The F1-C/U traffic between the donor CU3 and the IAB-DU is transmitted via the donor DU3.

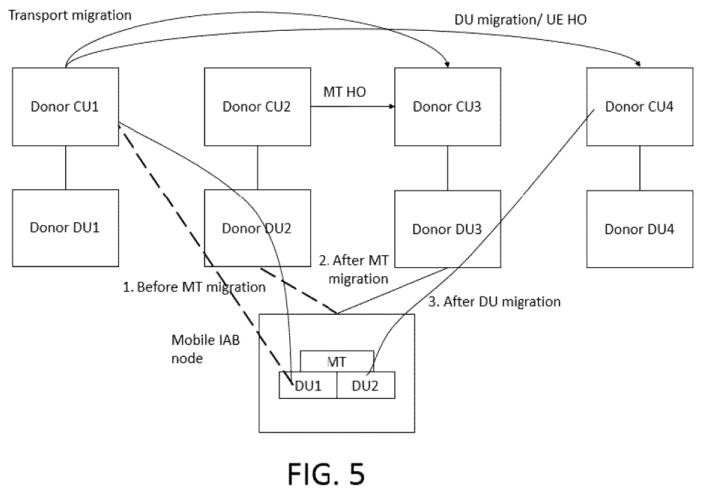

FIG. 5 shows a schematic diagram of an inter-donor full migration according to an embodiment of the present disclosure. In FIG. 5, the MT and its co-located DU are migrated to different IAB-donors. As shown in FIG. 5, the IAB-MT is migrated from the donor CU2 to the donor CU3 while the DU migration and the UE handover procedure are performed from the donor CU1 to a donor CU4. After the DU migration and the UE handover procedure, the F1 traffic between the logical DU2 and the donor CU4 are transferred via the donor DU3 which is controlled by the donor CU3. In this embodiment, the donor CU1 and the donor DU1 may be regarded as an IAB donor 1, the donor CU2 and the donor DU2 may be regarded as an IAB donor 2, and so on. The IAB donor 2 is a source (IAB) donor of the MT of the mobile IAB node. The IAB donor 3 is a target IAB donor of the MT of the mobile IAB node, The IAB donor 1 is a source (IAB) donor of the DU of the IAB node. The IAB donor 4 is a target donor of the DU of the IAB node.

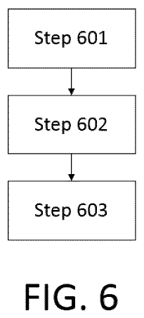

In an embodiment of the partial migration or the full migration, F1 traffic path needs to be transferred from a source path (i.e., via source donor DU) to a target path (i.e., via target donor DU) during the partial migration or the full migration. For example, the F1 terminating donor may initiate an IAB transport migration management request message to the target donor, to transfer the F1 traffic path. In an embodiment, an F1-terminating donor UE XnAP ID and/or a non-F1 terminating donor UE XnAP ID may be included in the IAB transport migration management request message. The non-F1 terminating donor UE XnAP ID in the IAB transport migration management request message may be set/configured by the method/process shown in FIG. 6:

Step 601: optionally, the F1 terminating donor XnAP ID (which is allocated by the F1-terminating donor used to identify the mobile IAB node) is sent from the source donor of the MT to the target donor of the MT. For example, the F1 terminating donor XnAP ID may be transmitted in the handover request message for the IAB-MT.

Step 602: optionally, the XnAP ID allocated by the target donor of the MT (i.e., target donor XnAP ID) is sent from the source donor of the MT to the F1-terminating donor.

Step 603: The F1 terminating donor sends IAB transport migration management request message to the target donor of the MT. The message includes the F1 terminating donor XnAP ID and/or the target donor XnAP ID.

In FIG. 6, the target donor of the MT is able to associate the received IAB transport migration management request message with the corresponding IAB-MT.

In an embodiment of the partial migration or the full migration, if CHO (conditional handover) is used for the IAB-MT, the source donor of the IAB-MT may not be aware of the target cell of the IAB-MT before sending a handover request message. The F1-terminating donor of the IAB node may need to acknowledge the target cell information of the IAB-MT.

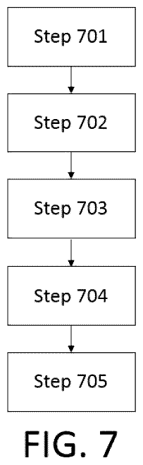

FIG. 7 shows a flowchart of a process according to an embodiment of the present disclosure. The process shown in FIG. 7 comprises the following steps:

Step 701: The source donor of the IAB-MT sends a handover request message to the target donor of the IAB-MT.

Step 702: The target donor of the IAB-MT sends a handover request ACK (acknowledge) message to the source donor of the IAB-MT.

Step 703: The source donor of the IAB-MT sends an RRCreconfiguration with a CHO configuration to the IAB-MT. Optionally, new triggering condition for sending target information of the IAB-MT could be configured to the MT by the source donor of the IAB-MT. The triggering condition information configured by the source donor of the IAB-MT includes at least one of: a measurement threshold for a serving cell, a measurement threshold for a SpCell/PCell/PSCell (special cell/primary cell/primary secondary cell), a measurement threshold for a neighbor cell, a measurement threshold for conditional reconfiguration candidate cell, a threshold for measurement offset between the SpCell and a conditional reconfiguration candidate cell. The above measurement threshold may be configured for measurements of RSRP (reference signal received power), RSRQ (reference signal received quality) or SINR (Signal to Interference Noise Ratio).

Step 704: The mobile IAB node sends the target information to the source donor of the MT (e.g., via RRC message), the target information of the MT includes at least one of a cell identity (e.g., PCI (physical cell identity) or NCGI (New Radio Cell Global Identifier)) of a target cell or a gNB ID of the target IAB donor. As an alternative or in addition, the mobile IAB node sends the target information to the F1-terminating donor (in this way, step 805 is not needed), e.g., via F1AP message.

Step 705: The source donor sends the target information to the F1-terminating donor based on the target information received from the mobile IAB node. The target information sent by the source donor of the MT includes at least one of: the cell identity (PCI or NCGI) of the target cell, the gNB ID of the target IAB donor or an identity of the IAB node (e.g., XnAP ID).

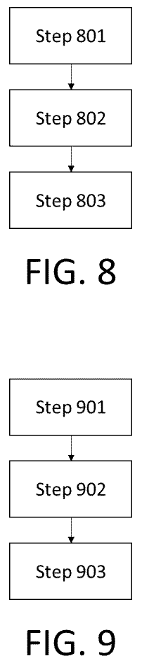

In an embodiment of the full migration, the IAB-DU and UE(s) served by the IAB-DU may need to be migrated. The method shown in FIG. 8 shows how the F1-terminating donor (i.e., the IAB-DU's source donor) determines the target donor for the DU migration, i.e. the target gNB of the UE(s) served by the IAB-DU.

Step 801: The donor of the IAB-DU (also called source donor of the IAB-DU) sends a request message to another IAB-donor (also called the second IAB donor, e.g., neighbor IAB-donor/candidate IAB-donor), a request message includes at least one of the following: QoS information of traffic to be migrated, the number of UEs served by the IAB-DU, speed/velocity of the IAB node, a location of the IAB node, a BAP routing ID, or a BH RLC channel ID.

Step 802: The second IAB donor sends a response message to the donor of the IAB DU, the response message includes at least one of the following: information of traffic (e.g., traffic index or QoS index) can be added, the number of UEs which can be migrated, the BAP routing ID, or the BH RLC channel ID.

Step 803: The donor of the IAB-DU selects one IAB donor as the target donor for the IAB-DU based on the received response message.

In an embodiment of the full migration, the MT migration is executed after the DU migration and/or the DU and the MT are migrated to different donors. After the target logical DU completes the F1 setup with the target donor of the DU, the target donor of the DU may need to send F1 setup completion to the source donor of the DU, such that the source donor of the DU could initiate a UE handover procedure towards the target donor of the DU. However, the target donor of the DU may not be aware of the source donor of the DU.

FIG. 9 shows a flowchart of a process/method for informing the target donor of the DU about the source donor of the DU according to an embodiment of the present disclosure. In an embodiment, the information of the source donor of the DU is transmitted to the target donor of the DU for transmitting the F1 setup completion indication.

Step 901: optionally, IAB donor (e.g., the source donor of the DU) sends an XnAP ID allocated by the IAB donor for the IAB node to the IAB node (e.g., via RRC message or F1 message).

Step 902: The target logical DU sends a F1 setup request message to the target donor of the DU. The F1 setup request message includes at least one of the following: mobile IAB indication, identity of the source donor of the DU, identity of the IAB node (e.g., BAP address/C-RNTI/XnAP ID allocated by the DU's source donor), a DU ID of the source logical DU. In this embodiment, the source donor of the DU is the donor which has F1 connection with the source logical DU, i.e., another logical DU in the mobile IAB node.

Step 903: The target donor of the DU sends a F1 setup completion message to the source donor of the DU. The F1 setup completion message includes at least one of the following: F1 setup completion indication, the identity of IAB node, the identity of DU, the identity of MT (e.g., XnAP ID/BAP address/C-RNTI allocated by the source donor of the DU).

In an embodiment, the IAB node (e.g., source logical DU) sends a F1 setup completion message/indication to the source donor of the DU of the IAB node (i.e., the IAB donor which has the F1 connection with the source logical DU of the IAB node), e.g., after receiving an F1 setup response message from a target donor of the IAB node. The F1 setup completion message/indication is used to indicate that the target logical DU of the IAB node has completed the F1 setup procedure with the IAB donor to which the target logical DU is migrated. The F1 setup completion message may comprise at least one of: the F1 setup completion indication or an identity of the target donor of the target logical DU (i.e., the IAB donor which has F1 connection with the target logical DU).

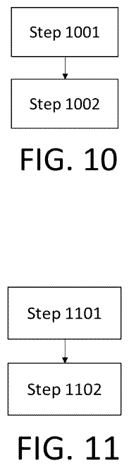

In an embodiment of the full migration, there may be two logical DUs (i.e., source logic DU and target logic DU) in the mobile IAB node for performing the DU migration. The target logic DU may need to be allocated an internet protocol IP address if different IP addresses are used for the two logical DUs. The IP address may be allocated to the target logical DU via the methods shown in FIGS. 10 to 12.

In FIG. 10, the mobile IAB-MT sends an IP address request to the IAB donor of the mobile IAB-MT, to request the IP address for target logical DU (step 1001). The IP address request may include at least one of: the number of requested IP addresses, IP address usage (e.g., F1-C, F1-U, all traffic), a DU migration indication, a target logical DU indication, or a topology indication. The IAB donor of the mobile IAB-MT sends IP address information for the target logical DU to the IAB-MT, e.g., via an RRC message (step 1002). The IP address information may include at least one of: allocated IP address(es), the IP address usage, the DU migration indication, the target logical DU indication, or the topology indication.

In step 1101 shown in FIG. 11, the F1 terminating donor of the IAB node sends an IP address request to the target IAB donor of the IAB-MT. The IP address request may include at least one of: the number of requested IP addresses, the IP address usage (e.g., F1-C, F1-U, all traffic), the DU migration indication, the target logical DU indication, or the topology indication.

In step 1102, the IAB target donor of the IAB-MT sends IP address information for the target logical DU to the IAB-MT, e.g., via the RRC message. The IP address information may include at least one of: the allocated IP address(es), the IP address usage, the DU migration indication, the target logical DU indication, or the topology indication.

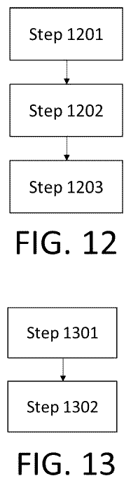

In FIG. 12, the F1 terminating donor of the IAB node sends an IP address request to the target IAB donor of the IAB-MT (step 1301). The IP address request may include at least one of: the number of requested IP addresses, the IP address usage (e.g., F1-C, F1-U, all traffic), the DU migration indication, the target logical DU indication, or the topology indication.

In step 1202, the target IAB donor of the IAB-MT sends IP address information for the target logical DU to the F1 terminating donor of the IAB node via the Xn interface/message. The IP address information may include at least one of: allocated IP address(es), the IP address usage, the DU migration indication, the target logical DU indication, or the topology indication.

In step 1203, the F1 terminating donor sends the IP address information to the IAB-DU node (e.g., the source logical DU) via the F1 message (i.e., via F1 interface). The IP address information includes at least one of: allocated IP address(es), the IP address usage, the DU migration indication, the target logical DU indication, or the topology indication.

In an embodiment, during the full migration, the two logical DUs in the IAB node may have F1 connections with two different IAB donors separately. In this embodiment, an uplink (UL) mapping may be configured for the target logical DU.

FIG. 13 shows a schematic diagram of a method/process according to an embodiment of the present disclosure. In FIG. 13, the source donor of the DU (i.e., the donor of the source logical DU) sends UL mapping info used at the source logical DU to the target donor of the DU (i.e., the donor of the target logical DU), e.g., via a handover request message (step 1301). The UL mapping information includes at least one of: BAP routing ID, BH RLC channel ID, Next-Hop BAP Address, traffic information (e.g., traffic index, QoS info of the traffic).

In step 1302, the target donor sends a UL mapping configuration for the target logical DU to the target logical DU.

In an embodiment, during the full migration, the two logical DUs of the IAB node may have F1 connections with two different IAB donors separately. Under such conditions, the IAB node may need to know the sharing of the two logical DUs.

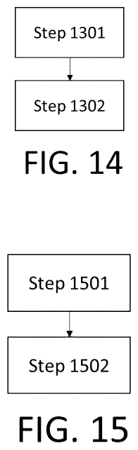

FIG. 14 shows a schematic diagram of a method/process according to an embodiment of the present disclosure. In FIG. 15, an IAB donor sends a sharing indication to the IAB node, e.g., via RRC or F1AP message (step 1401). In this embodiment, the IAB donor may be the source donor of the MT, the target donor of the MT, the source donor of the DU or the target donor of the DU.

In Step 1402, the configuration (e.g., UL mapping configuration, DU cell configuration) or information (e.g., UE context information) of the source logical DU is delivered to the target logical DU.

In an embodiment of the full migration, the mobile IAB-MT and it's co-located DU are migrated to different donors. In this embodiment, the F1 setup procedure may need to be performed between the target logical DU and the target donor of the DU. The problem is how could DU's target donor obtain target logical DU's IP address (e.g., IP address used for F1-C or all traffic).

FIG. 15 shows a flowchart of a method according to an embodiment of the present disclosure. In step 1501, the source logical DU sends an IP address (e.g., used for F1-C or all traffic, the IP address can be inner IP address and/or outer IP address) used by the target logical DU to the source donor of the DU. The source donor of the DU is the IAB donor which has F1 connection with the source logical DU.

In step 1502, the source donor of the DU sends the IP address of the target logical DU to the target donor of the DU.

In an embodiment of the full migration, the mobile IAB-MT and its co-located DU may be migrated to different donors. In this embodiment, the DL traffic sent from the target donor of the DU to the target logical DU may need to be transferred via the donor DU of the IAB-MT. Under such conditions, a DL mapping may need to be configured at the donor DU of the IAB-MT.

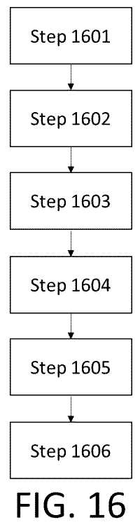

FIG. 16 shows a flowchart of a method according to an embodiment of the present disclosure. In step 1601, optionally, an IAB donor (e.g., donor of the IAB-MT) sends an XnAP ID allocated by the IAB donor for the IAB node to the IAB node, e.g., via an RRC message or an F1 message.

In step 1602, the target logical DU sends a F1 setup request message to the target donor of the DU of the IAB node. In an embodiment, the F1 setup request message includes an identity of the donor of the IAB-MT and/or an identity of IAB node allocated by the donor of the IAB-MT (e.g., BAP address, C-RNTI or XnAP ID).

In step 1603, the target logical DU or the target donor of the DU sends a F1 setup completion indication to a source donor of the DU.

In step 1604, the source donor of the DU initiates a handover procedure for UE(s) served by the IAB node towards the target donor of the DU.

In step 1605, the target donor of the DU sends assistance information to the donor of the IAB-MT. In an embodiment, the assistance information includes at least one of: an IP address of the IAB node, QoS information of the traffic, an identity of the IAB node allocated by the donor of the IAB-MT (e.g., BAP address, C-RNTI or XnAP ID). The donor of the IAB-MT therefore can configure DL mapping at the donor DU of the IAB-MT.

In step 1606, The donor of the IAB-MT sends a response message to a target donor of the DU. In an embodiment, the response message includes at least one of: DSCP and/or Flow label, traffic information (e.g., traffic index, QoS index, QoS of traffic). The donor of the DU can set the DSCP/Flow label field of IP header for the DL packets which need to be sent to the target logical DU.

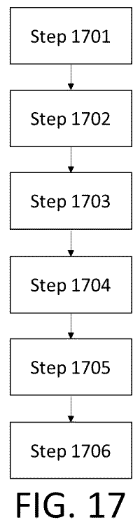

FIG. 17 shows a flowchart of a method according to an embodiment of the present disclosure. In step 1701, the source donor of the DU sends an identity of the donor of the IAB-MT and/or an identity of the IAB node allocated by donor of the IAB MT to the target donor of the DU. The identity of the IAB node may be an XnAP ID or a BAP address. If the identity of the IAB node is the BAP address, the BAP address needs to be:
sent from the donor of the IAB-MT to the source donor of the DU, or
sent from the target donor of the IAB-MT to the source donor of the IAB-MT and then sent from the source donor of the IAB-MT to the source donor of the DU,
sent from the IAB node to the source donor of the DU.

In step 1702, the target logical DU initiates an F1 setup procedure with the target donor of the DU.

In step 1703, the target logical DU or the target donor of the DU sends a F1 setup completion indication to a source donor of the DU.

In step 1704, the source donor of the DU initiates a handover procedure for UE(s) served by the IAB node towards the target donor of the DU.

In step 1705, the target donor of the DU sends assistance information to the donor of the IAB-MT. In an embodiment, the assistance information includes at least one of: an IP address of the IAB node, QoS information of the traffic, an identity of the IAB node allocated by the donor of the IAB-MT (e.g., BAP address, C-RNTI or XnAP ID). The donor of the IAB-MT therefore can configure DL mapping at the donor DU of the IAB-MT.

In step 1706, the donor of the IAB-MT sends a response message to a target donor of the DU. In an embodiment, the response message includes at least one of: DSCP and/or Flow label, traffic information (e.g., traffic index, QoS index, QoS of traffic). The donor of the DU can set the DSCP/Flow label field of IP header for the DL packets which need to be sent to the target logical DU.

In an embodiment of the partial migration, a physical cell ID (PCI) of the cell of the mobile IAB-DU may collide with other cells due to the movement of the mobile IAB-MT.

In an embodiment, the donor of the IAB-DU may detect the PCI collision. For example, the source donor CU of the IAB-MT may send information of the target donor CU of the IAB-MT (e.g., gNB ID of the target donor of the IAB-MT) to the donor CU of the IAB-DU. The donor of the DU can be aware of the gNB ID of the target donor of the IAB-MT. When/if there is an Xn connection between the donor CU of the DU and the target donor of the IAB-MT, the donor CU of the IAB-DU may obtain PCI(s) used in the serving cell(s) and neighbor cell(s) of the target donor CU of the IAB-MT, e.g., via (the existing) XnAP signaling (e.g., Xn SETUP/NG-RAN NODE CONFIGURATION UPDATE). Under such conditions, the donor of the IAB-DU is able to detect the PCI collision.

In response to the detection of the PCI collision, the donor of the IAB-DU sends a cell configuration information for the cell of the IAB-DU, e.g., via F1 signaling (e.g., GNB-CU CONFIGURATION UPDATE message). In an embodiment, the cell configuration information includes at least one of: one or more PCI(s), a target logical DU indication, a DU activation indication, two logical DU indication, or an NCGI.

In an embodiment, after receiving PCI(s) in the cell configuration information for the mobile IAB node from the F1-terminating donor, the mobile IAB node activates the 2nd logical DU (i.e., target logical DU) by using the received PCI(s).

In an embodiment for avoiding the PCI collision, the 2nd logical DU (i.e. the target logical DU) sends an F1 setup request message to the donor of the IAB-DU. The F1 setup request message includes at least one of: an identity of the source logical DU, an identity of the mobile IAB node, an identity of the mobile IAB-MT, a target logical DU indication, or two logical DU indication.

After the F1 connection between the 2nd logical DU and the donor of the IAB-DU is established, the donor of the IAB-DU may send an RRC reconfiguration message for the UEs to migrate the UEs from the cell(s) of the 1st logical DU (i.e., source logical DU) to the cell(s) of the 2nd logical DU.

In an embodiment for avoiding the PCI collision, the following steps may be performed:

Step 1: optionally, the donor of the IAB-DU sends a PCI of the cell of the IAB-DU to the target donor of the IAB-MT, e.g., via the Xn interface. As an alternative or in addition, the donor of the IAB-DU sends the PCI of the cell of the IAB-DU to the AMF via an NG signaling. The AMF sends the received PCI of the cell of the IAB-DU to the target donor of the IAB-MT via the NG signaling.

Step 2: the target donor of the IAB-MT sends assistance information to the donor of the IAB-DU. The assistance information may include at least one of: allocated PCI for the cell of the, PCI(s) of serving cell(s), PCI(s) of neighbor cell(s), PCI(s) which has been used, PCI(s) which has not been used. Based on the assistance information, the donor of the IAB-DU therefore can avoid the PCI collision.

In the present disclosure, the donor may refer to IAB donor.

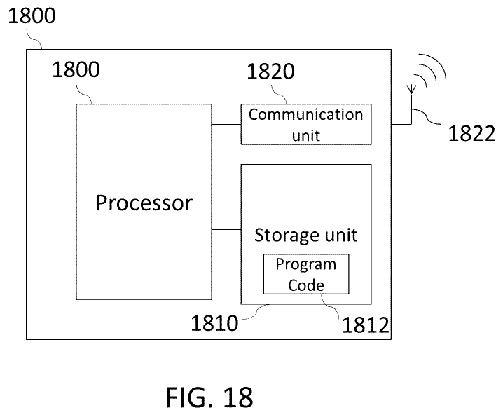

FIG. 18 relates to a schematic diagram of a wireless terminal 180 according to an embodiment of the present disclosure. The wireless terminal 180 may be a user equipment (UE), a mobile phone, a laptop, a tablet computer, an electronic book or a portable computer system and is not limited herein. The wireless terminal 180 may include a processor 1800 such as a microprocessor or Application Specific Integrated Circuit (ASIC), a storage unit 1810 and a communication unit 1820. The storage unit 1810 may be any data storage device that stores a program code 1812, which is accessed and executed by the processor 1800. Embodiments of the storage unit 1810 include but are not limited to a subscriber identity module (SIM), read-only memory (ROM), flash memory, random-access memory (RAM), hard-disk, and optical data storage device. The communication unit 1820 may a transceiver and is used to transmit and receive signals (e.g., messages or packets) according to processing results of the processor 1800. In an embodiment, the communication unit 1820 transmits and receives the signals via at least one antenna 1822 shown in FIG. 18.

In an embodiment, the storage unit 1810 and the program code 1812 may be omitted and the processor 1800 may include a storage unit with stored program code.

The processor 1800 may implement any one of the steps in exemplified embodiments on the wireless terminal 180, e.g., by executing the program code 1812.

The communication unit 1820 may be a transceiver. The communication unit 1820 may as an alternative or in addition be combining a transmitting unit and a receiving unit configured to transmit and to receive, respectively, signals to and from a wireless network node (e.g., a base station).

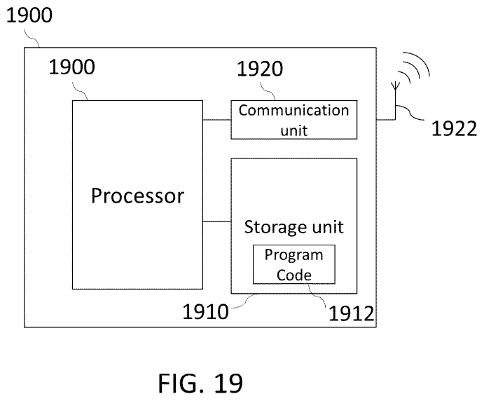

FIG. 19 relates to a schematic diagram of a wireless network node 190 according to an embodiment of the present disclosure. The wireless network node 190 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 190 may comprise (perform) at least one network function such as an access and mobility management function (AMF), a session management function (SMF), a user place function (UPF), a policy control function (PCF), an application function (AF), etc. The wireless network node 190 may include a processor 1900 such as a microprocessor or ASIC, a storage unit 1910 and a communication unit 1920. The storage unit 1910 may be any data storage device that stores a program code 1912, which is accessed and executed by the processor 1900. Examples of the storage unit 1910 include but are not limited to a SIM, ROM, flash memory, RAM, hard-disk, and optical data storage device. The communication unit 1920 may be a transceiver and is used to transmit and receive signals (e.g., messages or packets) according to processing results of the processor 1900. In an example, the communication unit 1920 transmits and receives the signals via at least one antenna 1922 shown in FIG. 19.

In an embodiment, the storage unit 1910 and the program code 1912 may be omitted. The processor 1900 may include a storage unit with stored program code.

The processor 1900 may implement any steps described in exemplified embodiments on the wireless network node 190, e.g., via executing the program code 1912.

The communication unit 1920 may be a transceiver. The communication unit 1920 may as an alternative or in addition be combining a transmitting unit and a receiving unit configured to transmit and to receive, respectively, signals to and from a wireless terminal (e.g., a user equipment or another wireless network node).

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

What is claimed is:

1. A wireless communication method for use in a source Integrated Access and Backhaul (IAB) donor, the wireless communication method comprising:
transmitting, to a target IAB donor, a handover request message for an IAB node,
transmitting, to the IAB node, a configuration of a handover to the target IAB donor,
receiving, from the IAB node, target information of the handover to the target IAB donor, and
transmitting, to an F1 terminating donor of the IAB node, the target information.

2. The wireless communication method of claim 1, wherein the configuration of the handover comprises at least one triggering condition configured by the source IAB donor for transmitting the target information.

3. The wireless communication method of claim 2, wherein the at least one triggering condition configured by the source IAB donor for transmitting the target information comprises at least one of:
a measurement threshold for serving cell,
a measurement threshold for a special cell
a measurement threshold for a primary cell
a measurement threshold of a primary secondary cell,
a measurement threshold for a neighbor cell,
a measurement threshold for a conditional reconfiguration candidate cell, or
a threshold for measurement offset between the special and the conditional reconfiguration candidate cell.

4. A wireless communication method for use in an Integrated Access and Backhaul (IAB) node, the wireless communication method comprising:
receiving, from a source IAB donor, a configuration of a handover to a target IAB donor, and
transmitting, to the source IAB donor or an F1 terminating donor of the IAB node, target information of the handover to the target IAB donor.

5. The wireless communication method of claim 4, wherein the configuration of the handover comprises at least one triggering condition configured by the source IAB donor for transmitting the target information.

6. The wireless communication method of claim 5, wherein the at least one triggering condition configured by the source IAB donor for transmitting the target information comprises at least one of:
a measurement threshold for serving cell,
a measurement threshold for a special cell
a measurement threshold for a primary cell
a measurement threshold of a primary secondary cell,
a measurement threshold for a neighbor cell,
a measurement threshold for a conditional reconfiguration candidate cell, or
a threshold for measurement offset between the special and the conditional reconfiguration candidate cell.

7. A wireless device, comprising a communication unit and at least one processor, the at least one processor being configured to:
transmit, via the communication unit, to a target IAB donor, a handover request message for an IAB node,
transmit, via the communication unit, to the IAB node, a configuration of a handover to the target IAB donor,
receive, via the communication unit, from the IAB node, target information of the handover to the target IAB donor, and
transmit, via the communication unit, to an F1 terminating donor of the IAB node, the target information.

8. The wireless device of claim 7, wherein the configuration of the handover comprises at least one triggering condition configured by the source IAB donor for transmitting the target information.

9. The wireless device of claim 8, wherein the at least one triggering condition configured by the source IAB donor for transmitting the target information comprises at least one of:
a measurement threshold for serving cell,
a measurement threshold for a special cell
a measurement threshold for a primary cell
a measurement threshold of a primary secondary cell,
a measurement threshold for a neighbor cell,
a measurement threshold for a conditional reconfiguration candidate cell, or
a threshold for measurement offset between the special and the conditional reconfiguration candidate cell.

10. A wireless device, comprising a communication unit and at least one processor, the at least one processor being configured to perform the method of claim 4.

11. The wireless device of claim 10, wherein the configuration of the handover comprises at least one triggering condition configured by the source IAB donor for transmitting the target information.

12. The wireless device of claim of claim 11, wherein the at least one triggering condition configured by the source IAB donor for transmitting the target information comprises at least one of:
a measurement threshold for serving cell,
a measurement threshold for a special cell
a measurement threshold for a primary cell
a measurement threshold of a primary secondary cell,
a measurement threshold for a neighbor cell,
a measurement threshold for a conditional reconfiguration candidate cell, or
a threshold for measurement offset between the special and the conditional reconfiguration candidate cell.

13. A non-transitory computer program product comprising a computer-readable program medium code stored thereupon, the computer-readable program medium code, when executed by at least one processor, causes the at least one processor to implement a wireless communication method recited in claim 1.

14. A non-transitory computer program product comprising a computer-readable program medium code stored thereupon, the computer-readable program medium code, when executed by at least one processor, causing the at least one processor to implement a wireless communication method recited in claim 4.
